(19) United States
(12) Patent Application Publication
(10) Pub. No.: US 2014/0213356 A1
(43) Pub. Date: Jul. 31, 2014

(54) VIDEO GAME PROCESSING APPARATUS AND VIDEO GAME PROCESSING PROGRAM

(71) Applicant: KABUSHIKI KAISHA SQUARE ENIX (also trading as SQUARE ENIX CO., LTD.), Tokyo (JP)

(72) Inventors: Hiroaki IWANO, Tokyo (JP); Naofumi TAKUMA, Tokyo (JP); Yasuhiro SATO, Tokyo (JP)

(73) Assignee: KABUSHIKI KAISHA SQUARE ENIX (also trading as SQUARE ENIX CO., LTD.), Tokyo (JP)

(21) Appl. No.: 14/163,509

(22) Filed: Jan. 24, 2014

(30) Foreign Application Priority Data
Jan. 29, 2013 (JP) P2013-014100

(51) Int. Cl. A63F 13/20

(52) U.S. Cl. CPC A63F 13/06
USPC 463/31; 463/43

(57) ABSTRACT

A video game processing apparatus for controlling progress of a video game is provided. A plurality of players carries out actions in turn in the video game, by which a predetermined action effect is generated. Action information in which an action and a support effect are associated with each other is stored in an action information memory. A player of the video game processing apparatus can carry out the action in the video game. The support effect is an effect generated in the video game due to an action. When an action executing request is received from the player, a support effect is set up in correspondence with the received action executing request. The support effect that has been set up before the action executing request is received is generated in a case where the action executing request is received.

### CROSS-REFERENCE TO RELATED APPLICATION

The present application relates to subject matter contained in Japanese Patent Application No. 2013-14100, filed on Jan. 29, 2013, the disclosure of which is expressly incorporated herein by reference in its entirety.

### BACKGROUND OF THE INVENTION

1. Field of the Invention

The present invention relates to a video game processing apparatus and a video game processing program for controlling progress of a video game in which a plurality of players carries out actions in turn, whereby a predetermined action effect is generated.

2. Description of the Related Art

Heretofore, a large number of video games in each of which an enemy is attacked by a plurality of players has been proposed. For example, such video games include one in which, when one player carries out an input of a special command, it is displayed that the input of the special command is carried out on a display screen of a terminal operated by each of the other players who participate in the video game (in particular, a network game) (see Japanese Patent Application Publication No. 2004-097656, for example).

In the video game having such a specification, the video game is caused to proceed by the plurality of players. For this reason, it is desired to heighten a feeling of fellowship and a cooperative feeing of each of the plurality of players.

### SUMMARY OF THE INVENTION

The present invention has been made in order to solve the problem described above, and it is an object of the present invention to heighten a feeling of fellowship and a cooperative feeing of each of a plurality of players in a video game.

In order to achieve the above object, in one aspect of the present invention, the present invention is directed to a video game processing apparatus for controlling progress of a video game. In this case, a plurality of players carries out actions in turn, by which a predetermined action effect is generated. The video game processing apparatus according to the present invention includes an action information memory for storing action information, an action and a support effect being associated with each other in the action information, a player being able to carry out the action in the video game, the support effect being an effect generated in the video game due to an action.

The video game processing apparatus also includes an action executing request receiver for receiving an action executing request from the player.

The video game processing apparatus also includes a support effect setter for setting up a support effect corresponding to the action executing request.

The video game processing apparatus also includes a support effect generator for generating the support effect that has been set up before the action executing request is received in a case where the action executing request receiver receives the action executing request.

By configuring the video game processing apparatus as described above, it is possible to heighten a feeling of fellowship and a cooperative feeing of each of the plurality of players in the video game.

In the video game processing apparatus according to the present invention, it is preferable that the support effect is an effect that is set up temporarily for each group which is established by the players of a predetermined number and that influences a parameter of at least one of the players.

In the video game processing apparatus according to the present invention, it is preferable that the support effect generator generates the support effect together with an action effect according to the action indicated by the action executing request received by the action executing request receiver.

In the video game processing apparatus according to the present invention, it is preferable that the video game processing apparatus further includes: a game screen display request receiver for receiving a display request to display a game screen for receiving the action executing request from the player; and a game screen display controller for displaying the game screen in a case where the game screen display request receiver receives the display request, the game screen including a function to inform the player of existence of the support effect set up by the support effect setter.

In the video game processing apparatus according to the present invention, it is preferable that the video game is a battle game between an enemy character and the plurality of players. In this case, the video game processing apparatus further includes: a termination determiner for determining whether a termination condition of the battle game is satisfied or not in a case where the action executing request receiver receives the action executing request, wherein the support effect generator generates the support effect in a case where the termination determiner determines that the termination condition is not satisfied.

In the video game processing apparatus according to the present invention, it is preferable that the video game processing apparatus further includes: a job information memory for storing job information, the job information being information on a job, the job being able to be set up to each player, the job information indicating a kind of the support effect; and a job setter for setting up the job to the player. In this case, the support effect setter sets up the support effect according to the job set up to the player.

Moreover, in another aspect of the present invention, the present invention is directed to a non-transitory computer-readable medium including a video game processing program product for causing a computer to control progress of a video game. In this case, a plurality of players carries out actions in turn, by which a predetermined action effect is generated. Further, the computer includes an action information memory for storing action information, an action and a support effect being associated with each other in the action information, a player being able to carry out the action in the video game, the support effect being an effect generated in the video game due to an action. The video game processing program product according to the present invention causes the computer to execute steps including receiving an action executing request from the player.

The steps also include setting up a support effect corresponding to the action executing request.

The steps also include generating the support effect that has been set up before the action executing request is received in a case where the action executing request receiver receives the action executing request.

According to the present invention, it is possible to heighten a feeling of fellowship and a cooperative feeing of each of a plurality of players in a video game.

### BRIEF DESCRIPTION OF THE DRAWINGS

The foregoing and other objects, features and advantages of the present invention will become more readily apparent from the following detailed description of a preferred embodiment of the present invention that proceeds with reference to the appending drawings:

FIG. 1 is a block diagram showing an example of a configuration of a video game processing system;

FIG. 2 is a block diagram showing an example of a configuration of a video game processing server;

FIG. 3 is an explanatory drawing for explaining an outline of a video game;

FIG. 4 is an explanatory drawing showing an example of a storage state of action information;

FIG. 5 is an explanatory drawing showing an example of a storage state of job information;

FIG. 6 is an explanatory drawing showing an example of a storage state of battle related information;

FIG. 7 is a flowchart showing an example of support effect related processing; and

FIG. 8 is an explanatory drawing for explaining a battle screen that shows a support effect.

### DETAILED DESCRIPTION OF THE INVENTION

Hereinafter, an example of one embodiment of the present invention will be described with reference to the appending drawings.

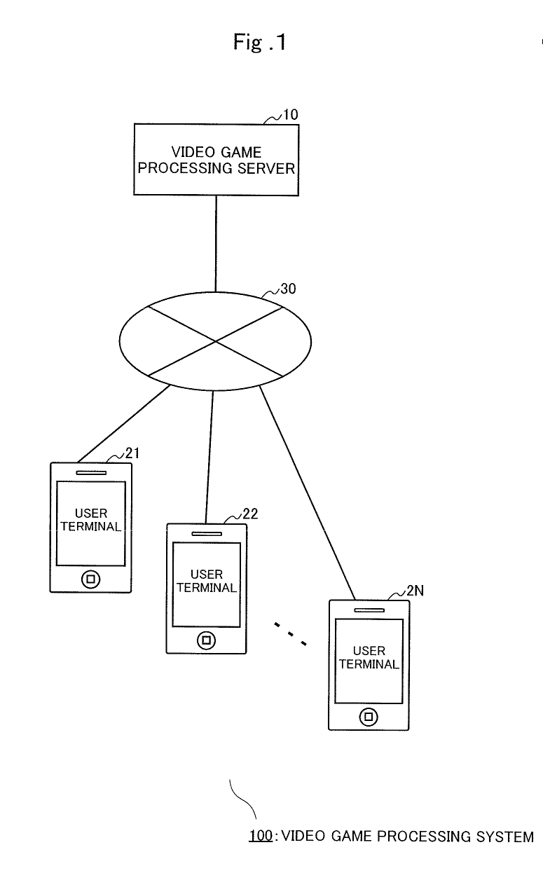

FIG. 1 is a block diagram showing an example of a configuration of a video game processing system 100 according to one embodiment of the present invention. As shown in FIG. 1, the video game processing system 100 includes: a video game processing server 10; and a plurality of user terminals 21 to 2N (“N” is an arbitrary integer) respectively used by a plurality of users. In this regard, the configuration of the video game processing system 100 is not limited to this configuration. The video game processing system 100 may be configured so that a single user terminal is used by a plurality of users. Alternatively, the video game processing system 100 may be configured so as to include a plurality of servers.

Each of the video game processing server 10 and the plurality of user terminals 21 to 2N is connected to a communication network 30 such as the Internet. In this regard, although it is not shown in the drawings, each of the plurality of user terminals 21 to 2N is connected to the communication network 30 by carrying out data communication with a base station managed by a carrier by means of a wireless communication line.

The video game processing system 100 has various kinds of functions to control progress of a video game (a so-called online game) in which a plurality of players plays in the same virtual space (including a synchronous virtual space and an asynchronous virtual space).

The video game processing server 10 is managed by an administrator of the video game processing system 100, and has various kinds of functions to provide (or deliver) information on the video game to the user terminals 21 to 2N.

The video game processing server 10 is configured by an information processing apparatus such as a WWW server, and includes a storage medium for storing various kinds of information. In this regard, it is preferable that in the video game processing system 100, the information regarding the video game is managed by the video game control server 10 in the light of the fact that a processing load on each of the plurality of user terminals 21 to 2N is to be reduced in the video game processing system 100. However, the video game processing system 100 may be configured so that each of the plurality of user terminals 21 to 2N manages part of the information on the video game.

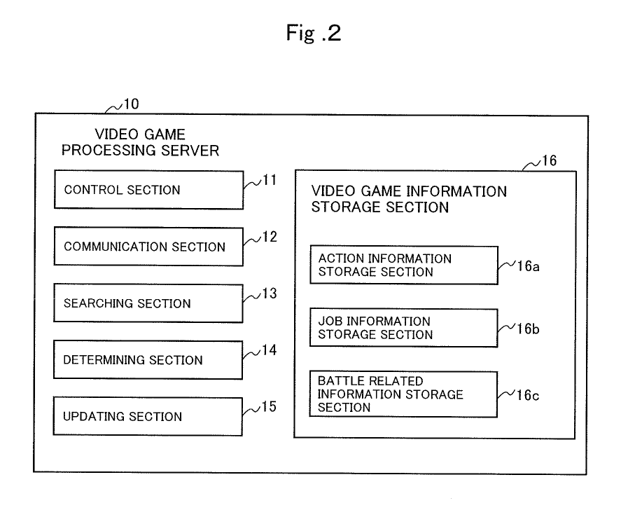

FIG. 2 is a block diagram showing an example of a configuration of the video game processing server 10. As shown in FIG. 2, the video game processing server 10 includes: a control section 11; a communication section 12; a searching section 13; a determining section 14; an updating section 15; and a video game information storage section 16.

The control section 11 includes a CPU, a ROM and the like, and has a function to carry out controls of the whole video game processing server 10 in accordance with control programs stored in the video game information storage section 16.

The communication section 12 has a function to carry out communication with each of the plurality of user terminals 21 to 2N via the communication network 30 such as the Internet.

The searching section 13 has a function to search for information according to progress of the video game (for example, information according to a progress status of the video game in each user terminal) from among various kinds of information stored in the video game information storage section 16.

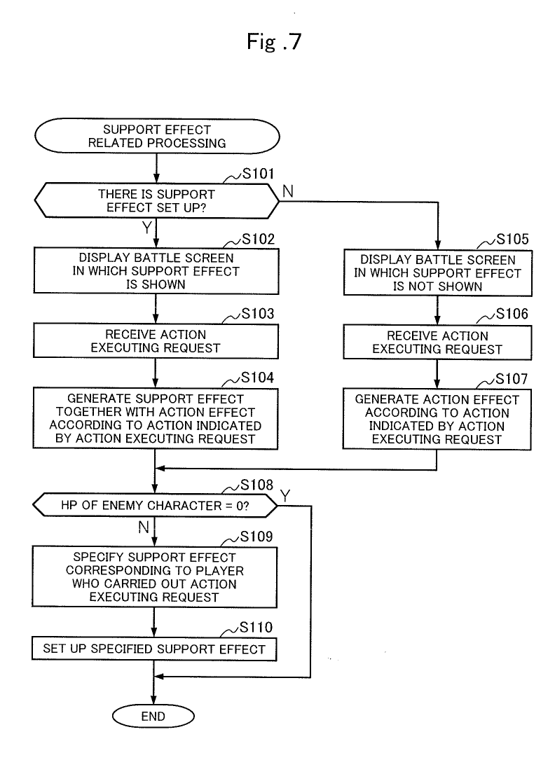

The determining section 14 has a function to carry out various kinds of determinations in accordance with progress of the video game. In the present embodiment, the determining section 14 has a function to carry out various kinds of determinations in support effect related processing (will be described later; see FIG. 7) on the basis of various determination conditions stored in the video game information storage section 16.

The updating section 15 has a function to update various kinds of information stored in the video game information storage section 16 in accordance with progress of the video game. In this regard, the video game processing server 10 may be configured so that the information used for updating processing is acquired from the plurality of user terminals 21 to 2N. Alternatively, the video game processing server 10 may be configured so that such information is prepared in advance in the video game information storage section 16.

The video game information storage section 16 is configured by a database apparatus, for example. The video game information storage section 16 is a storage medium for storing various kinds of information on the video game whose progress is controlled by the video game control system 100 and various kinds of data such as control programs for the video game.

Here, an outline of the video game whose progress is controlled by the video game processing system 100 will be described. In the present embodiment, the video game processing system 100 controls progress of a so-called online RPG (online role-playing game) that is played by the corresponding player in each of the plurality of user terminals 21 to 2N. Namely, the video game processing system 100 controls progress of the video game in which some relationship between the plurality of users who respectively operate the plurality of user terminals 21 to 2N is generated.

In the present embodiment, the video game is configured so as to include a battle scene (that is, a configuration of a so-called online battle RPG) in which a player (that is, a user of the user terminal) causes a main character (a player character) of a story to use virtual cards.

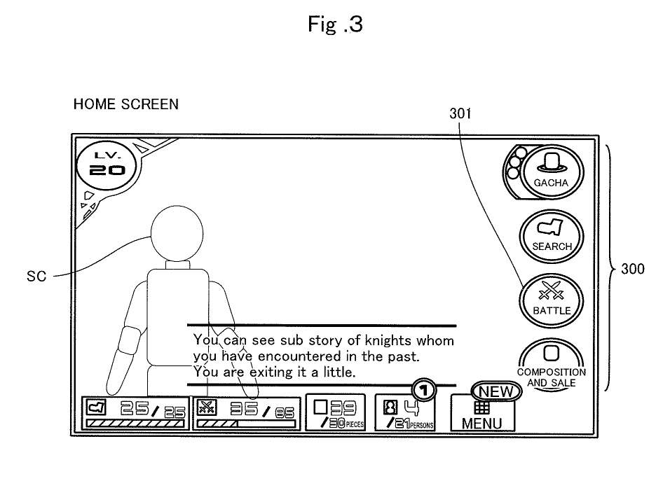

FIG. 3 is an explanatory drawing for explaining an outline of the video game. More specifically, FIG. 3 shows an example of a game screen (that is, a so-called home screen) that becomes a basis in causing the video game to proceed. As shown in FIG. 3, in the present embodiment, an image SC and a virtual button display area 300 are provided on the home screen. The image SC indicates a character (support character) that supports the player (or the player character) in the video game. The virtual button display area 300 is used for receiving a display request of any of various kinds of game screens. For example, when the player selects one virtual button 301 displayed in the virtual button display area 300 (for example, when the player presses a portion on which the virtual button 301 is displayed by means of a finger of the player), the game screen shifts from the home screen to a screen (for example, another player selecting screen) for carrying out a battle against other player (not shown in the drawings).

The video game according to the present embodiment includes, as a battle using a virtual card, a battle in which players fight with each other and a battle (that is, a boss battle) in which the plurality of players fight a specific enemy character. Hereinafter, the boss battle will be described. In the boss battle, each player establishes a deck by combining virtual cards possessed by the player before start of a battle, and attacks an enemy character using the deck that indicates various statuses including an HP and an offensive power (ATK). Then, in a case where a winning condition against an enemy character by the attack of each player (for example, a condition that an HP of the enemy character is reduced to zero within a time limit) is satisfied, a privilege (for example, a virtual card corresponding to the defeated enemy character) is given to each of the players who participate in the boss battle in accordance with a level of the enemy character and the degree of contribution of each player (for example, the amount of the applied damage, the degree determined by giving the finishing blow to the enemy character or the like). Further, an experience value is given to each player character in accordance with the degree of damage applied to the enemy character. The experience value given to the player character influences the level of the player character.

Further, in the present embodiment, the player is allowed to select an arbitrary job among plural kinds of jobs. Various capabilities (abilities) are set up to the job, and the player is allowed to receive an effect according to the ability corresponding to the selected job. The player is also allowed to arbitrarily switch the possessed jobs. Further, a level is set to the job. For example, when the player carries out a battle with the selected job, the experience value of the job is accumulated. Then, when the experience value of the job reaches a fixed value, the job level is increased, and the ability of the job is improved (for example, extension of the effect and an increase in an incidence ratio).

In this regard, in the present embodiment, the player consumes an action point (AP) to search a virtual space, thereby encountering an enemy character. Then, the player consumes a battle cost (BC) according to a cost set up to each virtual card included in the deck to attack the enemy character. Further, the player receives a support request from other player who was registered as a friend, whereby the player can also attack an enemy character encountered by the other player (friend).

In the present embodiment, in order to control progress of the video game described above, the video game information storage section 16 includes: an action information storage section 16a; a job information storage section 16b; and a battle related information storage section 16c (see FIG. 2).

The action information storage section 16a is a storage medium for storing action information. The action information is information on an action that the player (or the player character) can carry out in the video game. In the present embodiment, the action information indicates a kind of action and an effect generated by carrying out the action.

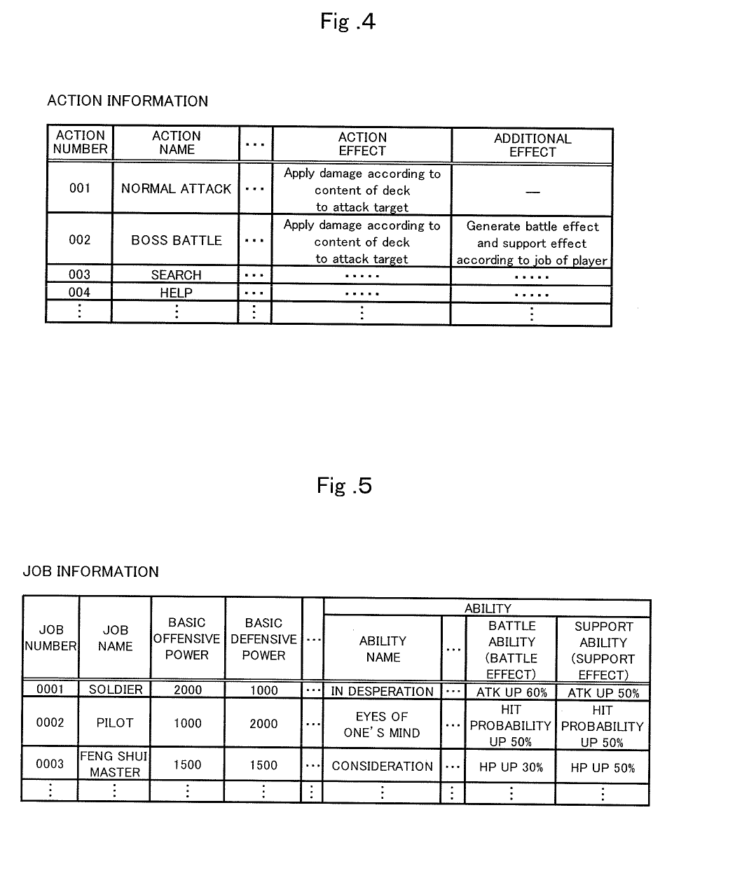

FIG. 4 is an explanatory drawing showing an example of a storage state of the action information stored in the action information storage section 16a. As shown in FIG. 4, the action information contains: an action number capable of uniquely specifying an action; a name of the action; an effect (action effect) generated by carrying out the action; and an effect (additional effect) generated together with the action effect.

In the present embodiment, the actions that the player can carry out includes a normal attack and a boss battle. Here, the “normal attack” is a battle in which the player fights the encountered enemy character on a one-to-one basis, and the effect “to give a damage according to the content of the deck to an attack target” is set up as the action effect. On the other hand, no effect is set up as the additional effect. Further, the “boss battle” is an action that can be carried out when a group (order of chivalry) is constructed (or established) by a plurality of players (or a plurality of player characters). In the boss battle, the same content of “normal attack” is set up as the action effect, and the effect “to generate a battle effect and a support effect according to a job of the player” is set up as the additional effect. Namely, in a case where the player carries out a “boss battle” as the action in the video game and each player attacks a specific enemy character (for example, the enemy character encountered by the player who belongs to the order of chivalry), effects (that is, a battle effect and a support effect) according to a “job” (will be described later) are generated as an additional effect in addition to the same action effect as the “normal attack”.

In this regard, the configuration of the action information is not limited to this configuration. For example, the video game processing system 100 may be configured so that the action information contain various actions such as “search” that is an action for encountering an enemy character, and “help (or assistance)” to restore an HP of other player in a boss battle in addition to the “normal attack” and the “boss battle”. Further, the video game processing system 100 may be configured so that any additional effect (including a support effect according to a job) is generated for a part or all of the actions.

The job information storage section 16b is a storage medium for storing job information. The job information is information on jobs each of which influences characteristics of each player (or a player character operated by each player). In the present embodiment, the job information indicates: a kind of a job; and an effect generated by setting up the job.

FIG. 5 is an explanatory drawing showing an example of a storage state of the job information stored in the job information storage section 16b. As shown in FIG. 5, the job information contains: a job number for uniquely specifying a job; a name of the job; a basic offensive power; a basic defensive power; and an ability.

Here, each of the basic offensive power and the basis defensive power means a parameter that influences a damage in a boss battle. These powers rise in proportion to a job level.

Further, there are two types of abilities including a battle ability and a support ability. One ability is set up to each job in an initial state (a state of level one). In this regard, one ability or both abilities may not be set up depending upon the job.

The battle ability is activated during the boss battle, and an effect to influence on the damage is obtained by the battle ability. A new battle ability is set up by improving the job (that is, level up) depending upon the job. Further, data related to the battle ability contain “principle” in addition to an ability level. The “principle” can be selected as a weak point of an enemy character in a boss battle. The ability having the “principle” selected as the weak point raises (or increases) the damage amount applied to the enemy character by the attack.

The support ability exerts an effect on a next attacker in the boss battle. For that reason, no support ability influences a damage at a first attack. In this regard, a merit that a privilege as a discoverer of the enemy character is given is provided to a first attacker for that. Further, data related to the support ability contain three types of ability names in addition to the ability level. More specifically, a display name for a menu (for example, eyes of one's mind), a display name for a support section (for example, hit probability up) and a display name for an attack representing screen (for example, eyes of one's mind) are included in each support ability. In this regard, the video game processing system 100 may be configured so that two or all of the three types of abilities have the same name.

In this regard, the configuration of the job information is not limited to this configuration. For example, the video game processing system 100 may be configured so that the job information contains an ability that can be set up using an in-game item and an effect generated by using the in-game item.

The battle related information storage section 16c is a storage medium for storing battle related information. The battle related information is information on a battle carried out in accordance with progress of the video game. In the present embodiment, the battle related information indicates information on the boss battle, in particular, a battle (that is, a group battle) between an enemy character that each player can encounter incidentally for a predetermined period of time (for example, one week) and a group to which the player who encountered the enemy character belongs.

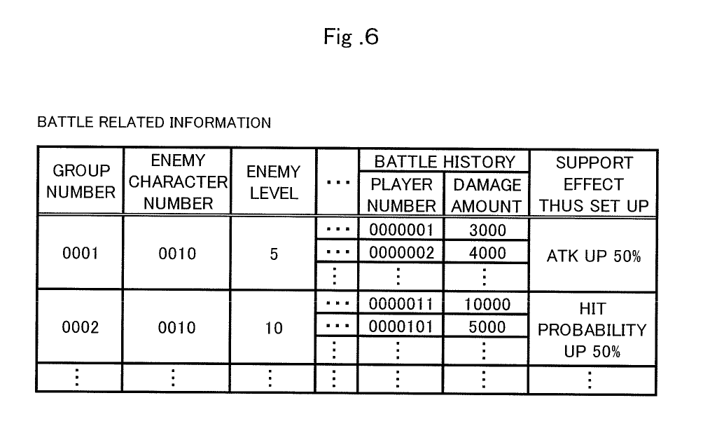

FIG. 6 is an explanatory drawing showing an example of a storage state of the battle related information stored in the battle related information storage section 16c. As shown in FIG. 6, the battle related information contains: a group number for uniquely specifying each of groups; an enemy character number for uniquely specifying an enemy character; an enemy level of the enemy character; a battle history; and a support effect thus set up.

Each of the groups is a group that is established by players of a predetermined number (for example, thirty players) in accordance with a predetermined rule (for example, a rule in which a player with a closer level is preferred, and the like; or in a random manner). Further, in the present embodiment, establishment and breakup of a group is executed automatically at predetermined intervals (for example, every one week) during an event period, for example. In this regard, the rule to determine a group is not limited to this rule. For example, the video game processing system 100 may be configured so that players carry out group registration.

The enemy level is raised (or increased) by a predetermined number (for example, one level) whenever the group won an enemy character. Namely, the player who belongs to the group encounters an enemy character by means of searching, and carries out a group battle. When the group battle is terminated, the player encounters an enemy character by means of the searching again. The player plays the video game in this manner.

The battle history is an action history of the player who belongs to the group. In the present embodiment, a player number indicating a player who carried out an attack against an enemy character (that is, boss battle; see FIG. 4) as the action, and an effect by the action (that is, the action effect; more specifically, the amount of damage applied to the enemy character), are stored as the battle history.

The support effect thus set up (that is, the set-up support effect) means a support effect that is set up temporarily for each group. Namely, for example, in a case where a player X who belongs to a group G attacks an enemy character NPC at first, an attack on which a battle ability AB of a job A selected by the player X is influenced is carried out, and a support ability AS of the job A is set up for a next attack by the other player. In a case where a player Y attacks the same opponent (the enemy character NPC) after the player X subsequently, an attack on which a battle ability BB of a job B selected by the player Y and the support ability AS set up at the previous attack are influenced is carried out, and the support ability BS of the job B is set up for a next attack by other player. In this regard, the video game processing system 100 may be configured so that, in a case where the same player attacks the enemy character in succession, the support ability set up at the first attack does not influence on the attack at the next attack. In this regard, when a new support effect is set up, the support effect that has been set up until then becomes unavailable (for example, the setup is released).

In this regard, the configuration of the battle related information is not limited to this configuration. The video game processing system 100 may be configured so that the battle related information indicates a relationship between the support effect and the plurality of players, for example, so as to accumulate a history of the support effects that have been set up in the past and to make the support effects available (for example, to display a plurality of support effects from which the player can select one), or so as not to make the support effects available in a case where a support effect is not used even though a predetermined time (for example, for ten minutes) elapses since the support effect was set up (for example, in a case where the player attacks no other player or no enemy player for ten minutes).

Each of the plurality of user terminals 21 to 2N is managed by a user (or a player) who carries out the video game, and is configured by a mobile communication terminal, such as a cellular phone terminal, a PDA (Personal Digital Assistants) and a mobile game apparatus, by which the user can play a network delivery-type game, for example. Each of the plurality of user terminals 21 to 2N has hardware (for example, a display device for displaying a game screen, an audio output device and the like) and software to carry out a video game by connecting the user terminal 21 to 2N to the communication network 30 and carrying out communication with the video game processing server 10. In this regard, the video game processing system 100 may be configured so that the plurality of user terminals 21 to 2N can directly communicate with each other without passing through the video game processing server 10.

Next, an operation of the video game processing system 100 according to the present embodiment will be described. In this regard, the content of operations and/or processing with no relationship to the present invention may be omitted.

FIG. 7 is a flowchart showing an example of support effect related processing carried out by the video game processing system 100. In the support effect related processing, processing related to setup and generation of a support effect is carried out. Hereinafter, an operation of the video game processing system 100 when to carry out the support effect related processing will be described with reference to FIG. 7 that shows the flowchart including processing carried out by each of the plurality of user terminals 21 to 2N and processing carried out by the video game processing server 10.

The support effect related processing is started in a case where the video game processing server 10 receives a battle screen display request from any of the user terminals 21 to 2N (hereinafter, will be described using the user terminal 21 as an example) operated by each player when a group configured by the plurality of players is established, for example.

In the support effect related processing, the video game processing server 10 first determines whether a support effect corresponding to a the group G1, to which a user (the player X1) of the user terminal 21 belongs, is set up or not (Step S101). In the present embodiment, when a battle screen display request is received while presenting a group number from the user terminal 21, the video game processing server 10 determines whether a support effect corresponding to the group number is set up or not by referring to the battle related information (see FIG. 6).

Here, in a case where it is determined that the support effect is set up (“Yes” at Step S101), the video game processing server 10 causes the user terminal 21 to display a battle screen, in which the support effect thus set up is shown, on a display screen of the display device included in the user terminal 21 (Step S102).

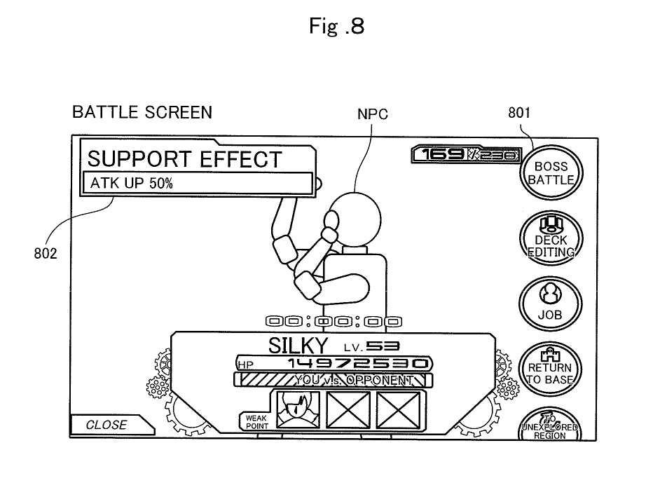

FIG. 8 is an explanatory drawing for explaining an example of the battle screen that shows the support effect. As shown in FIG. 8, an enemy character NPC; a virtual button 801 for receiving a request (executing request) to execute a boss battle against the enemy character NPC; and a support effect display area 802 in which the support effect thus set up is displayed; are provided on the battle screen according to the present embodiment. In this regard, the video game processing system 100 may also be configured so that a support ability (that is, an ability name) is displayed in the support effect display area 802. Further, the video game processing system 100 may be configured so that the user terminal 21 displays information (for example, part of the job information corresponding to the support effect and/or part of the battle related information) related to the support effect thus set up when the support effect display area 802 is pressed (or pushed) by the player X1.

When the battle screen in which the support effect is shown is displayed, the user terminal 21 receives an action executing request from the player X1 (Step S103). Here, in a case where it is determined that the action executing request is received by receiving a selection of the virtual button 801 by the player X1, the user terminal 21 causes the video game processing server 10 to generate a support effect together with an action effect according to the action indicated by the action executing request (Step S104). In the present embodiment, when the action executing request is received from the user terminal 21, the video game processing server 10 causes the user terminal 21 to display an attack representing screen on the basis of a deck configuration of the player X1, the support effect displayed in the support effect display area 802, and the damage amount that the player X1 applies to the enemy character NPC (not shown in the drawings). Further, at this time, the video game processing server 10 updates the battle related information in accordance with the damage amount of the enemy character NPC calculated on the basis of the deck configuration, the support effect and the like. In this regard, the configuration of the attack representing screen is not limited particularly so long as a player is allowed to recognize the damage amount applied to an enemy character. However, it is preferable that the video game processing system 100 is configured so that the player is allowed to recognize that a support effect is generated.

On the other hand, in a case where it is determined in the process at Step S101 that no support effect is set up (“No” at Step S101), the video game processing server 10 causes the user terminal 21 to display a battle screen, in which the support effect is not shown, on the display screen of the display device included in the user terminal 21 (Step S105). In this regard, at this time, the video game processing system 100 may be configured so that the video game processing server 10 causes the user terminal 21 to display a battle screen indicating no support effect is set up. Further, the video game processing system 100 may also be configured so that the video game processing server 10 causes the user terminal 21 to display a battle screen that indicates a support effect set up when the player X1 carries out a boss battle against the enemy character NPC.

When the battle screen in which the support effect is not shown is displayed, the user terminal 21 receives an action executing request from the player X1 (Step S106). Then, when the action executing request is received, the user terminal 21 causes the video game processing server 10 to generate an action effect according to the action indicated by the action executing request (Step S107). In the present embodiment, when the action executing request is received from the user terminal 21, the video game processing server 10 causes the user terminal 21 to display an attack representing screen on the basis of the deck configuration of the player X1 and the damage amount that the player X1 applies to the enemy character NPC (not shown in the drawings). Further, at this time, the video game processing server 10 updates the battle related information in accordance with the damage amount of the enemy character NPC, which is calculated on the basis of the deck configuration, the battle effect and the like.

When the action effect (for example, an effect to subtract the damage amount applied by the player from the HP of the enemy character NPC) is generated, the video game processing server 10 determines whether the HP of the enemy character NPC becomes zero or not (Step S108). Here, in a case where it is determined that the HP of the enemy character NPC becomes zero (“Yes” at Step S108), the video game processing server 10 terminates the processing herein. In this case, the video game processing server 10 causes the user terminal 21 to display a game screen indicating that the player character won the enemy character NPC, and to give a privilege according to the degree of contribution to each player who belongs to the group G1 to which the player X1 belongs.

On the other hand, in a case where it is determined that the HP of the enemy character NPC does not become zero (“No” at Step S108), the video game processing server 10 specifies a support effect corresponding to the player X1 who carried out the action executing request (Step S109). In the present embodiment, the video game processing server 10 specifies the support effect corresponding to the player X1 by specifying the job selected by the player X1 (see FIG. 5).

When the support effect is specified, the video game processing server 10 sets up the specified support effect to the battle related information storage section 16c (Step S110) (see FIG. 6), and terminates the processing herein. In this regard, in the present embodiment, the video game processing server 10 erases the support effect thus set up (that is, the support effect generated in the process at Step S104), and sets up the specified support effect (that is, overwrites the specified support effect).

As explained above, in the embodiment described above, the video game processing apparatus (for example, the video game processing server 10, the user terminal 21, or the video game processing system 100; The same applies hereinafter.) for controlling progress of a video game in which a plurality of players carries out actions in turn, by which a predetermined action effect is generated, is configured so as to: include the action information storage section 16a for storing action information, an action (for example, the boss battle) and a support effect (for example, an offensive power up 50%) being associated with each other in the action information, the player X1 being able to carry out the action in the video game, the support effect being an effect generated in the video game due to an action; receive an action executing request from the player X1 (for example, Step S103); set up a support effect corresponding to the action executing request (for example, Step S110); and generate the support effect that has been set up before the action executing request is received in a case where the action executing request is received (for example, Step S104). Therefore, it is possible to heighten a feeling of fellowship and a cooperative feeing of each of the plurality of players in the video game.

Namely, it becomes clear for a player that the player carries out an action, by which next player can obtain a profit. In addition, it becomes clear for the player that, in a case where there is a support effect set up by an action of other player when the player carries out the action, the action of the other player influences the action of the player. Therefore, it is possible to heighten a feeling of fellowship and a cooperative feeing of each of the plurality of players in the video game.

Further, in the embodiment described above, the video game processing apparatus may be configured so as to generate the support effect together with an action effect according to the action (for example, the boss battle) indicated by the received action executing request (for example, to generate an effect in which an offensive power of a deck of the player is increased more than the support effect, and the damage amount according to the increased offensive power is subtracted from an HP of the enemy character NPC) (for example, Step S104). Therefore, it is possible for the player to clearly recognize a difference between the case where the player carries out the action while obtaining a support effect and the case where the player carries out the action without the support effect.

Further, in the embodiment described above, the video game processing apparatus may be configured so as to: receive a display request to display a game screen for receiving the action executing request from the player X1 (for example, receive the battle screen display request that causes start of the support effect related processing); and display the game screen, including a function to inform the player X1 of existence of the support effect thus set up in a case where the display request is received (for example, the battle screen including the support effect display area 802; see FIG. 8). Therefore, the player can utilize presence or absence of a support effect and a kind of the support effect as an action indicator. Namely, other player who will carry out an action later can determine whether to carry out an action by referring to the support effect to be generated, and thus, this makes it possible to improve interest of the player in the video game.

Further, in the embodiment described above, the video game processing apparatus may be configured so as to generate the support effect displayed on the game screen (for example, the support effect displayed in the support effect display area 802 of the battle screen) in a case where the action executing request is received from the player (for example, Step S103) after display of the game screen (for example, Step S102). Therefore, in a case where the plurality of players who belongs to the same group plays the video game at the same time, it is possible to effectively avoid a processing load of the video game processing apparatus from becoming excessive.

Namely, for example, in a case where a display request of the game screen is received from the player X2 who belongs to the same group as the player X1 after a support effect A is displayed on the game screen for the player X1, the video game processing apparatus displays the support effect A on the game screen for the player X2 while no action executing request is received from the player X1. Then, for example, in a case where an action executing request is received from the player X1, the video game processing apparatus causes the support effect A to influence on the action of the player X1. At this time, the video game processing apparatus sets up a support effect B corresponding to the player X1 to the battle related information storage section 16c, but does not update the game screen for the player X2. For that reason, in a case where an action executing request is received from the player X2 hereafter, the video game processing server 10 causes the support effect A to influence on the action of the player X2. By configuring the video game processing apparatus in this manner, it is possible to reduce a load of the video game processing apparatus without declining a feeling of fellowship and a cooperative feeing of each of the plurality of players compared with the case where the game screen of each of the plurality of players is updated whenever the battle related information is updated. In this regard, the video game processing apparatus may be configured so as to update the game screen of the related player whenever the battle related information is updated depending upon the number of participation allowed players, a processing capacity (throughput) of the video game processing apparatus, and the like.

In this regard, although it has not been mentioned particularly in the embodiment described above, the video game processing apparatus may be configured so that the video game is a battle game between the enemy character NPC and the plurality of players (for example, the plurality of players who belongs to the group to which the player X1 belongs), and so as to: determine whether a termination condition (for example, a condition that an HP of the enemy character NPC becomes zero) of the battle game is satisfied or not in a case where the action executing request is received (for example, Step S103); and generate the support effect in a case where it is determined that the termination condition is satisfied (for example, Step S104). By configuring the video game processing apparatus in this manner, it is possible to prevent one battle from becoming prolonged, and this makes it possible to advance progress of the video game (for example, the realization of a battle against an enemy character with a high level).

Further, in the embodiment described above, the video game processing apparatus may be configured so as to: include the job information storage section 16b for storing job information, the job information being information on a job, the job being able to be set up to each player, the job information indicating a kind of the support effect; set up the job to the player X1; and set up the support effect according to the job set up to the player X1 (for example, after execution of the action by the player X1) (for example, Step S110). Therefore, the player can select a job by taking a property of the support effect into consideration, and this makes it possible to improve interest of the player in the video game.

Further, in the embodiment described above, each of the plurality of user terminals 21 to 2N and the video game processing server 10 carries out the various processes described above in accordance with various control programs (for example, the video game processing program) stored in the storage device (memory) included in the user terminal 21 to 2N or the video game processing server 10 itself.

In this regard, the configuration of the video game processing system 100 is not limited to the configuration described above. For example, the video game processing system 100 may be configured so that the video game processing server 10 carries out a part or all of the processes that have been explained as the processing carried out by the user terminal. Alternatively, the video game processing system 100 may be configured so that any of the plurality of user terminals 21 to 2N (for example, the user terminal 21) carries out a part or all of the processes that have been explained as the processing carried out by the video game processing server 10. Further, the video game processing system 100 may be configured so that each of the user terminals 21 to 2N includes a part or all of the storage sections included in the video game processing server 10. Namely, the video game processing system 100 may be configured so that any one of the user terminal 21 and the video game processing server 10 in the video game processing system 100 includes a part or all of the functions included in the other thereof.

### INDUSTRIAL APPLICABILITY

The present invention is useful to heighten a feeling of fellowship and a cooperative feeing of each of a plurality of players in a video game.

What is claimed is:

1. A video game processing apparatus for controlling progress of a video game, a plurality of players carrying out actions in turn by which a predetermined action effect is generated, the video game processing apparatus comprising:
an action information memory for storing action information, an action and a support effect being associated with each other in the action information, a player being able to carry out the action in the video game, the support effect being an effect generated in the video game due to an action;
an action executing request receiver for receiving an action executing request from the player;
a support effect setter for setting up a support effect corresponding to the action executing request; and
a support effect generator for generating the support effect that has been set up before the action executing request is received in a case where the action executing request receiver receives the action executing request.

2. The video game processing apparatus according to claim 1, wherein the support effect is an effect that is set up temporarily for each group which is established by the players of a predetermined number and that influences a parameter of at least one of the players.

3. The video game processing apparatus according to claim 1, wherein the support effect generator generates the support effect together with an action effect according to the action indicated by the action executing request received by the action executing request receiver.

4. The video game processing apparatus according to claim 1, further comprising:
a game screen display request receiver for receiving a display request to display a game screen for receiving the action executing request from the player; and
a game screen display controller for displaying the game screen in a case where the game screen display request receiver receives the display request, the game screen including a function to inform the player of existence of the support effect set up by the support effect setter.

5. The video game processing apparatus according to claim 1, wherein the video game is a battle game between an enemy character and the plurality of players,
wherein the video game processing apparatus further comprises:
a termination determiner for determining whether a termination condition of the battle game is satisfied or not in a case where the action executing request receiver receives the action executing request, and
wherein the support effect generator generates the support effect in a case where the termination determiner determines that the termination condition is not satisfied.

6. The video game processing apparatus according to claim 1, further comprising:
a job information memory for storing job information, the job information being information on a job, the job being able to be set up to each player, the job information indicating a kind of the support effect; and
a job setter for setting up the job to the player,
wherein the support effect setter sets up the support effect according to the job set up to the player.

7. A non-transitory computer-readable medium including a video game processing program product for causing a computer to control progress of a video game, a plurality of players carrying out actions in turn by which a predetermined action effect is generated,
wherein the computer comprises an action information memory for storing action information, an action and a support effect being associated with each other in the action information, a player being able to carry out the action in the video game, the support effect being an effect generated in the video game due to an action,
wherein the video game processing program product causes the computer to execute:
receiving an action executing request from the player;
setting up a support effect corresponding to the action executing request; and
generating the support effect that has been set up before the action executing request is received in a case where the action executing request receiver receives the action executing request.
